(19) United States
(12) Patent Application Publication
(10) Pub. No.: US 2025/0258860 A1
(43) Pub. Date: Aug. 14, 2025

(54) SYSTEM AND METHOD OF ORGANIZING DATA

(71) Applicant: HONEYWELL INTERNATIONAL INC., Charlotte, NC (US)

(72) Inventors: Bhabesh Acharya, Bangalore (IN); Upender Paravastu, Bangalore (IN); Kumaresh Baabu, Madurai (IN); Durga Rath, Bangalore (IN)

(21) Appl. No.: 18/633,572

(22) Filed: Apr. 12, 2024

(30) Foreign Application Priority Data
Feb. 9, 2024 (IN) 202411008814

(51) Int. Cl. G06F 16/45; G06F 16/435; G06F 16/48

(52) U.S. Cl. CPC G06F 16/45; G06F 16/435; G06F 16/48

(57) ABSTRACT

A system and a method of organizing data is described. The method comprises extracting a first textual information from electronic documents, and segmenting it into one or more chunks of sentences including at least one word. First numerical representations of the one or more chunks are generated using a machine learning model. Identity and association between the electronic documents, the one or more chunks, and the first numerical representations are stored in a memory. Images are extracted from the electronic documents and a second textual information is extracted from the images. Second numerical representations of keywords present in the second textual information are generated using the machine learning model. The first numerical representations are matched with the second numerical representations for determining an association of the images with the first textual information. The association of the images with the first textual information is also stored in the memory.

### TECHNICAL FIELD

Present disclosure relates to a system and a method of organizing data, and particularly, relates to organization of data using word embeddings.

### BACKGROUND

Data is an important asset for any business enterprise. The data may be related to consumers, employees, products/services, or operations carried by the business enterprise. The data may be stored in electronic documents of different types, such as text files, images, audio files or videos. Further, data related to a single concept or thing may be present in several electronic documents. Additionally, numerous versions of such electronic documents may be present. Therefore, it is an onerous task to collect relevant information from all the documents, and process and present the information collectively. Furthermore, as the business enterprise continues to grow, the data may get richer and larger, and the electronic documents containing the data may become vast in number. With this, extracting valuable information from the electronic documents becomes more challenging.

Thus, there is a need for a system and a method of organizing data such that a variety of information present in several electronic documents could be accessed easily and quickly.

### SUMMARY OF THE INVENTION

The present invention relates to a method of organizing data. The method comprises extracting a first textual information from one or more electronic documents. The processor segments the first textual information into one or more chunks of sentences including at least one word, based on pre-defined rules. The pre-defined rules may be deployed using one or more of semantic text classification models and semantic text extraction models. First numerical representations of the one or more chunks are generated using a machine learning model. Thereafter, identity of each of the one or more electronic documents, the one or more chunks, and the first numerical representations is stored in a memory. An association between the one or more chunks, the first numerical representations, and a respective electronic document of the one or more electronic documents is also stored in the memory.

Successively, one or more images are extracted from the one or more electronic documents. Further, a second textual information including one or more keywords is extracted from the one or more images. The one or more key words may be extracted using optical character recognition. Second numerical representations of the one or more keywords are generated using the machine learning model. The first numerical representations are matched with the second numerical representations for determining an association of the one or more images with the first textual information based on the association of the first numerical representations with the one or more chunks. In one implementation, the memory is updated when a value of the matching of the first numerical representations and the second numerical representations is greater than a pre-defined threshold. The memory is updated to store details of association of the one or more images with the first textual information.

In one aspect, an electronic document including the first textual information and the one or more images associated with the first textual information is generated.

In one aspect, the association of the one or more images with the first textual information includes one or more of an index, identity, and link to location of the one or more images contained in the one or more electronic documents. The association of the one or more images with the first textual information is stored as a single entry of a table.

In one aspect, the method of organizing data further comprises receiving a user query including one or more query words. The user query may be processed using a natural language processing technique for determining the one or more query words. A similarity between the one or more query words and the first textual information may be determined. A response including the first textual information and the one or more images associated with the first textual information may be provided based on the similarity between the one or more query words and the first textual information.

In one aspect, a video may be generated using the one or more images associated with the first textual information overlaid on a speech synthesized audio sequence of the first textual information. The one or more images are captured from a video file.

A system for organizing data is described. The system comprises a processor and a memory storing program instructions which, when executed by the processor, causes the processor to perform several functions. The processor extracts a first textual information from one or more electronic documents. The processor segments the first textual information into one or more chunks of sentences including at least one word, based on pre-defined rules. The processor generates first numerical representations of the one or more chunks, using a machine learning model. The processor stores identity of each of the one or more electronic documents, the one or more chunks, and the first numerical representations in the memory. An association between the one or more chunks, the first numerical representations, and a respective electronic document of the one or more electronic documents is also stored in the memory. The processor extracts one or more images from the one or more electronic documents. The processor extracts a second textual information from the one or more images. The second textual information includes one or more keywords. The processor generates second numerical representations of the one or more keywords using the machine learning model. The processor matches the first numerical representations with the second numerical representations for determining an association of the one or more images with the first textual information based on the association of the first numerical representations with the one or more chunks. The processor updates the memory for storing the association of the one or more images with the first textual information.

A non-transitory computer-readable storage medium storing program instructions for organizing data is described. The instructions, when executed, perform several steps including extracting a first textual information from one or more electronic documents. The instructions further perform segmenting of the first textual information into one or more chunks of sentences including at least one word, based on pre-defined rules. The instructions further perform generation of a first numerical representations of the one or more chunks, using a machine learning model. The instructions further perform storing of identity of each of the one or more electronic documents, the one or more chunks, and the first numerical representations. An association between the one or more chunks, the first numerical representations, and a respective electronic document of the one or more electronic documents is also stored. The instructions further perform extraction of one or more images from the one or more electronic documents. The instructions further perform extraction of a second textual information from the one or more images. The second textual information includes one or more keywords. The instructions further perform generation of a second numerical representations of the one or more keywords, using the machine learning model. The instructions further perform matching of the first numerical representations with the second numerical representations for determining an association of the one or more images with the first textual information based on the association of the first numerical representations with the one or more chunks. The instructions further perform updating of the memory for storing the association of the one or more images with the first textual information.

### BRIEF DESCRIPTION OF THE DRAWINGS

The accompanying drawings constitute a part of the description and are used to provide further understanding of the present disclosure. Such accompanying drawings illustrate the embodiments of the present disclosure which are used to describe the principles of the present disclosure. The embodiments are illustrated by way of example and not by way of limitation in the figures of the accompanying drawings in which like references indicate similar elements. It should be noted that references to “an” or “one” embodiment in this disclosure are not necessarily to the same embodiment, and they mean at least one. In the drawings:

FIG. 1 illustrates a system for organizing data, in accordance with an embodiment of the present disclosure;

FIG. 2 illustrates a block diagram showing components of a server configured to organize data, in accordance with an embodiment of the present disclosure;

FIG. 3 illustrates a block diagram of a method of organizing data, in accordance with an embodiment of the present disclosure;

FIG. 4 illustrates a portion of information stored in a vector database, in accordance with an embodiment of the present disclosure;

FIG. 5 illustrates a portion of information stored in an image database, in accordance with an embodiment of the present disclosure;

FIG. 6 illustrates a portion of information stored in the vector database, in accordance with an embodiment of the present disclosure;

FIG. 7 illustrates a user device communicating with the server for accessing the organized data, in accordance with an embodiment of the present disclosure; and

FIGS. 8a and 8b cumulatively illustrate a flow chart of a method of organizing data, in accordance with an embodiment of the present disclosure.

### DETAILED DESCRIPTION OF THE INVENTION

The present disclosure provides a system and a method of organizing data. The method includes extracting a first textual information from one or more electronic documents. The first textual information is segmented into one or more chunks of sentences including at least one word, based on pre-defined rules. First numerical representations of the one or more chunks are generated using a machine learning model. Identity of each of the one or more electronic documents, the one or more chunks, and the first numerical representations is stored in a memory. An association between the one or more chunks, the first numerical representations, and a respective electronic document of the one or more electronic documents is also stored in the memory.

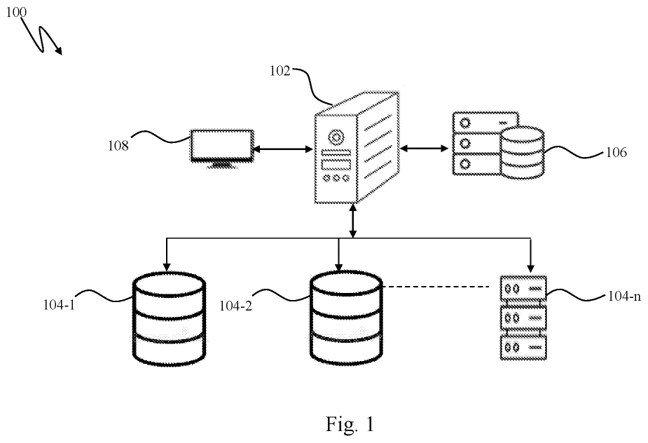

Successively, one or more images are extracted from the one or more electronic documents. A second textual information including one or more keywords is then extracted from the one or more images. Second numerical representations of the one or more keywords are generated using the machine learning model. The first numerical representations are matched with the second numerical representations for determining an association of the one or more images with the first textual information based on the association of the first numerical representations with the one or more chunks. Details of the association of the one or more images with the first textual information are updated in the memory. In this manner, a link between textual information and relevant images may be obtained. Detailed operation of the system and the method of organizing data is provided successively with reference to FIG. 1 through FIG. 8.

FIG. 1 illustrates a block diagram of a system 100 for organizing data. The system 100 may include a server 102 installed locally or implemented over a cloud network. The server 102 may be connected with one or more data sources 104-1 to 104-n (collectively labelled as 104) for retrieving electronic documents. The electronic documents may be present in different formats, such as word documents, presentations, Portable Document Format (PDF) files, image files, and movie files. These electronic documents may include information in different forms, such as text, image, and video.

The server 102 may extract data from the electronic documents, specifically textual information and images. The images may be processed for extraction of a second textual information using techniques including Optical Character Recognition (OCR), Maximum Stable Extremal Regions (MSER), and Stroke Width Transformation (SWT). The server 102 may identify one or more keywords from the second textual information. The first textual information and the one or more keywords gathered from the second textual information may be matched to determine an association between the images and the first textual information. In some implementations, numerical representations of the first textual information and the one or more keywords gathered from the second textual information may be obtained, using machine learning models, and the numerical representations may be matched for determining the association.

The server 102 may store, in a database 106, details of the electronic documents, the first textual information present in the electronic documents, the images, and the association between the images and the first textual information. It must be noted that instead of storing the electronic documents and the images as such, references to storage locations of the electronic documents and the images may be stored in the database 106. In one implementation, such details may be stored in the database 106 in a tabular format.

In one implementation, the server 102 may develop a text file by including the first textual information along with associated images. Further, a video file may also be prepared by text to audio conversion of the first textual information and overlaying the audio over the text file. The text file or the video file may be provided to a user in response to his query.

Successively, a user accessing a user device 108 may send a query to the server 102 for obtaining some information. The server 102 may refer to the database 106 and identify a text file or a video file including information matching with keywords of the query. Based on the matching, the server 102 may provide the text file or the video file to the user. In this manner, the user will not be required to scan several documents identified to be relevant towards his query. Further, not only textual information but relevant visual information, such as images related to the textual information may also be included in the text file or the video file provided to the user, in response to the query.

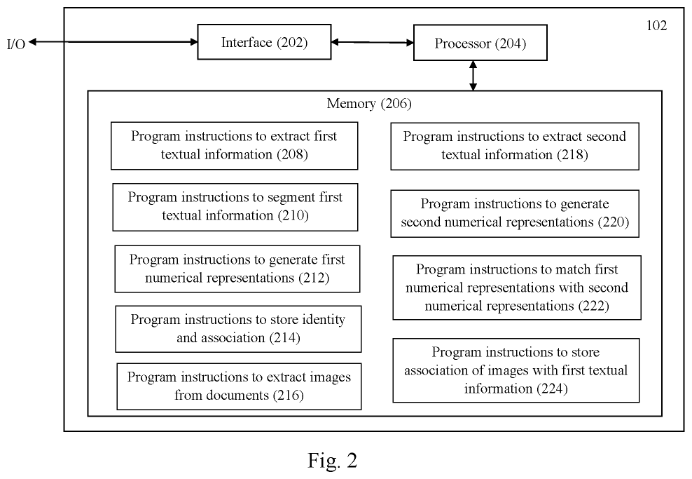

FIG. 2 illustrates a block diagram showing components of the server 102 configured to organize data, in accordance with an embodiment of the present disclosure. The server 104 may comprise an interface 202, a processor 204, and a memory 206. The memory 206 may store functional code i.e. program instructions to extract first textual information 208, program instructions to segment first textual information 210, program instructions to generate first numerical representations 212, program instructions to store identity and association 214, program instructions to extract images from documents 216, program instructions to extract second textual information 218, program instructions to generate second numerical representations 220, program instructions to match first numerical representations with second numerical representations 222, and program instructions to store association of images with first textual information 224.

The program instructions to extract first textual information 208 may cause the processor 204 to extract the first textual information from electronic documents. The first textual information may be extracted using a suitable technique such as Optical Character Recognition (OCR), Regular Expressions (Regex), Natural Language Processing (NLP), keyword extraction, Information Retrieval (IR), document Structure analysis, PDF text extraction, Named Entity Recognition (NER), and web scraping.

The program instructions to segment first textual information 210 may cause the processor 204 to segment the first textual information into sentence chunks including at least one word. The sentence chunks may be made up of individual words or words that are defined using part-of-speech tags. The first textual information may be segmented based on pre-defined rules i.e. text extraction rules. The text extraction rules may assist in identification of words or patterns to be included or excluded from a sentence chunk. Specifically, the text extraction rules refer to predefined patterns or criteria used for identification of specific information from the documents.

Regular Expressions (Regex) may be used as a text extraction rule for matching specific strings or patterns within the first textual information. Keyword matching may be used for identification of specific keywords or phrases indicating presence of relevant information. Named Entity Recognition (NER) may be used to recognize and extract named entities such as names, locations, organizations, etc. Part-of-speech tagging may be used to identify the grammatical parts of speech of words in a sentence through linguistic analysis. Length or Position-based rule may be used for identifying strings based on length or position of the strings within the first textual information. Thresholds and confidence scores may be used for setting confidence thresholds or scores to filter out or prioritize extracted information based on its reliability.

The program instructions to generate first numerical representations 212 may cause the processor 204 to generate, using a machine learning model, first numerical representations of the one or more chunks. The first numerical representations are alternatively referred as word embeddings. Word embeddings are numeric vectors representing words in a lower-dimensional space, and helps in preserving of syntactical and semantic information. Word embeddings allow words with similar meanings to have a similar representation.

The program instructions to store identity and association 214 may cause the processor 204 to store identity of each of the one or more electronic documents, the one or more chunks, and the first numerical representations in a memory. Further, an association between the one or more chunks, the first numerical representations, and a respective electronic document of the one or more electronic documents may also be stored in the memory.

The program instructions to extract images from documents 216 may cause the processor 204 to extract one or more images from the one or more electronic documents. The images may be extracted based on their features, using different image extraction techniques. The features may include color, shape, texture, and spatial layout.

The program instructions to extract second textual information 218 may cause the processor 204 to extract a second textual information from the one or more images. The second textual information may include one or more keywords and may be extracted using machine learning techniques. The machine learning techniques may include Efficient Accurate Scene Text detector (EAST), Convolutional-Recurrent Neural Network (CRNN), and SEE—Semi-Supervised End-to-End Scene Text Recognition (STN-net/SEE). Further, Optical Character Recognition (OCR) techniques, such as MaskOCR, TransOCR, PerSec, Context-based Contrastive Learning for Scene Text Recognition (ConCLR), Automotive, Bidirectional and Iterative Network (ABINet), VisionLan, Semantic Reasoning Network (SRN), Parallel, Iterative, and Mimicking Network (PIMNet), Semantics Enhanced Encoder-Decoder Framework (SEED) or Attentional Scene Text Recognizer with Flexible Rectification (ASTER) may be used for identification of the characters.

The program instructions to generate second numerical representations 220 may cause the processor 204 to generate, using the machine learning model, second numerical representations of the one or more keywords. The second numerical representations are alternatively referred as word embeddings. The word embeddings are numeric vectors representing words in a lower-dimensional space, and helps in preserving of syntactical and semantic information. The word embeddings allow words with similar meanings to have a similar representation.

The program instructions to match first numerical representations with second numerical representations 222 may cause the processor 204 to match the first numerical representations with the second numerical representations for determining an association of the one or more images with the first textual information based on the association of the first numerical representations with the one or more chunks.

The program instructions to store association of images with first textual information 224 may cause the processor 204 to update the memory to store the association of the one or more images with the first textual information. The program instructions 208 through 224 also include standard libraries or reference to the standard libraries required for execution of one or more tasks by the server 102 or an Artificial Intelligence/Machine Learning model. Elaborative functioning of the program instructions 208 through 224 would become clear upon reading the details provided successively.

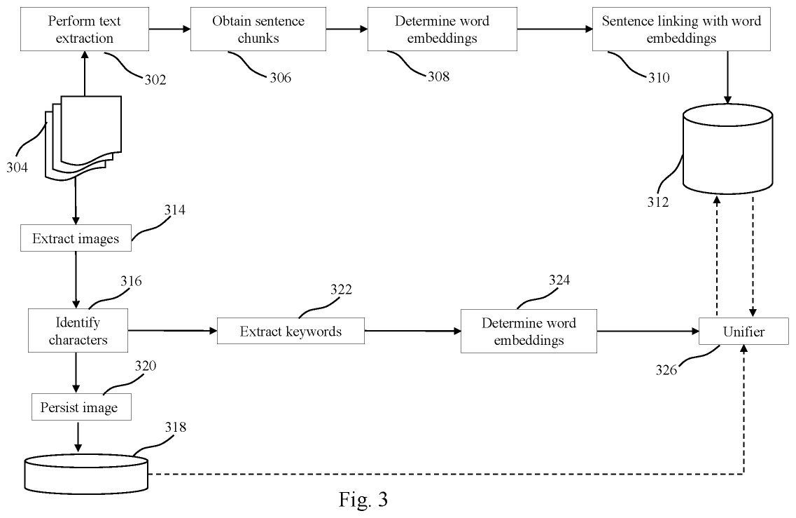

FIG. 3 illustrates a block diagram of a method of organizing data, in accordance with an embodiment of the present disclosure. At first, documents 304 to be processed are identified. The documents 304 may be identified based on a user input or a toll like web scraper. The user input may include a web/server location where the documents 304 are present. The web scraper may be used for extracting data or the documents 304 from different web locations, such as websites. The web may fetch and parse HTML or other structured data from the websites and then extract relevant information.

Post identification, text extraction is performed on the documents 304, at step 302. The documents 304 may be text containing documents of different formats, such as plain text (.txt), rich text format (.rtf), markdown (.md), Hyper Text Markup Language (.html), Portable Document Format (.pdf), Microsoft™ Word (.docx, .doc), OpenDocument Text (.odt), LaTeX (.tex), JavaScript Object Notation (.json), and Extensible Markup Language (.xml).

The text extraction may be performed using a suitable technique such as Optical Character Recognition (OCR), Regular Expressions (Regex), Natural Language Processing (NLP), keyword extraction, Information Retrieval (IR), document Structure analysis, PDF text extraction, Named Entity Recognition (NER), and web scraping.

For example, the text extraction may be performed using the below mentioned program by NLP, using spaCy library.
import spacy
#Load the English NLP model from spaCy
nlp=spacy.load(“en_core_web_sm”)
#Sample text with information to extract
text=“““Albert Einstein was born on Mar. 14, 1879, in Ulm, Germany. He is best known for his theory of relativity and the equation E=mc\hat{ }2.
Einstein received the Nobel Prize in Physics in 1921 for his explanation of the photoelectric effect.”””
#Process the text using spaCy
doc=nlp(text)
#Extract named entities (persons, organizations, locations, etc.)
entities=[(ent.text, ent.label_) for ent in doc.ents]
#Extract relevant information based on specific patterns or rules
important_info=[ ]
#Extract birth date
for token in doc:
   if token.text.lower( )==“born” and token.dep_==“ROOT”:
      birth_date=doc[token.i+1].text+“ ”+doc[token.i+2].text
      important_info.append((“Birth Date”, birth_date))
#Extract Nobel Prize information
for sent in doc.sents:
   if “Nobel Prize” in sent.text:
      prize_info=sent.text.strip( )
      important_info.append((“Nobel Prize”, prize_info))
#Print the extracted information
print(“Named Entities:”, entities)
print(“Important Information:”, important_info)

By performing the text extraction on the documents 304, a first textual information is obtained. The first textual information may include one or more sentences present as one or more paragraphs or pointers.

The first textual information may be segmented to obtain one or more chunks of sentences (alternatively referred as sentence chunks) including at least one word, at step 306. The sentence chunks may be made up of individual words or words that are defined using part-of-speech tags. The first textual information may be segmented based on pre-defined rules i.e. text extraction rules. The text extraction rules may assist in identification of words or patterns to be included or excluded from a sentence chunk. Specifically, the text extraction rules refer to predefined patterns or criteria used for identification of specific information from the documents 304.

Regular Expressions (Regex) may be used as a text extraction rule for matching specific strings or patterns within the first textual information. Keyword matching may be used for identification of specific keywords or phrases indicating presence of relevant information. Named Entity Recognition (NER) may be used to recognize and extract named entities such as names, locations, organizations, etc. Part-of-speech tagging may be used to identify the grammatical parts of speech of words in a sentence through linguistic analysis. Length or Position-based rule may be used for identifying strings based on length or position of the strings within the first textual information. Thresholds and confidence scores may be used for setting confidence thresholds or scores to filter out or prioritize extracted information based on its reliability.

Successively, word embeddings are determined for the sentence chunks, at step 308. Word embeddings are numeric vectors representing words in a lower-dimensional space, and helps in preserving of syntactical and semantic information. The word embeddings allow words with similar meanings to have a similar representation. The word embeddings may be determined through different methods, such as machine learning models, feature extraction algorithms, Word2Vec, and Global Vectors for Word Representation (GloVe).

In one implementation, the word embeddings may be obtained using the below provided sample program implementing Word2Vec in python.
from gensim.models import Word2Vec
from nltk.tokenize import word_tokenize
import nltk
nltk.download(‘punkt’)
#Sample sentences for training the Word2Vec model
sentences=[
   “Word embeddings are dense vector representations of words.”,
   “They capture semantic relationships based on context.”,
   “Word2Vec is a popular method for creating word embeddings.”
]
#Tokenize the sentences into words
tokenized_sentences=[word_tokenize(sentence.lower( )) for sentence in sentences]
#Create Word2Vec model
model=Word2Vec(sentences=tokenized_sentences, vector_size=100, window=5, min_count=1, workers=4)
#Training the Word2Vec model
model.train(tokenized_sentences, total_examples=len(sentences), epochs=10)
#Get the vector representation of a word
word_vector=model.wv[‘word’]
print(“Vector representation of ‘word’:”, word_vector)

In the above provided sample program, sentences are tokenized into words using NLTK library, a Word2Vec model is created using Gensim, model is trained on tokenized sentences, vector representation of the word ‘word’ are retrieved from the trained model.

The sentence chunks are then linked with their word embeddings, at step 310. The sentence chunks linked with their word embeddings are stored in a memory or a database, such as a vector database 312. The vector database 312 may be capable of indexing and storing vector embeddings for fast retrieval and similarity search, with capabilities like CRUD operations, metadata filtering, and horizontal scaling. The vector embeddings are vector data representation carrying within them semantic information critical for AI to gain understanding and maintain a long-term memory they can draw upon when executing required tasks.

In one implementation, links to the words and inverted index links to document index of corresponding documents may be stored in the vector database 312. The inverted index link stores a record of where the corresponding documents (from which the words are extracted) are located in a table. The vector database 312 may store data as high-dimensional vectors, such as mathematical representations of features or attributes. Each vector has a certain number of dimensions, ranging from tens to thousands, depending on complexity and granularity of information.

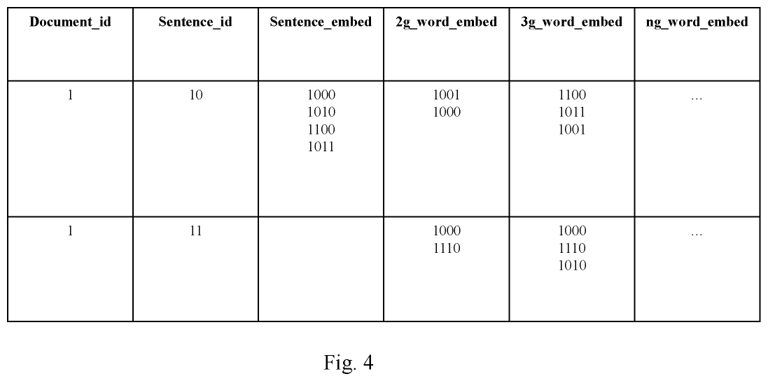

FIG. 4 illustrates a portion of information stored in the vector database 312, in accordance with an embodiment of the present disclosure. As illustrated, the vector database 312 may store document identity (Document_id), sentence chunk identity (Sentence_id), sentence chunk embeddings (Sentence_embed), and different n-gram word embeddings (2 g_word_embed, 3 g_word_embed, ng_word_embed). The n-gram word embeddings represent contiguous sequence of n items from a given sample of text. Similarly, 2 g_word_embed means the word embeddings having contiguous sequence of 2 items from a given sample of text.

The documents 304 may also be present as or may include image files or video files of different formats. For example, the image files or the video files may be present in Joint Photographic Experts Group (.jpg, .jpeg), Portable Network Graphics (.png), Graphics Interchange Format (.gif), Tagged Image File Format (.tiff, .tif), Bitmap (.bmp), WebP (.webp), Scalable Vector Graphics (.svg), High Efficiency Image Format (.heif, .heic), RAW, and Icon (.ico) formats. Further, the video files may be any of MPEG (Moving Picture Experts Group) (.mpeg, .mpg), MPEG-4 (.mp4), Audio Video Interleave (.avi), Matroska Video (.mkv), QuickTime File Format (.mov), Windows Media Video (.wmv), Flash Video (.flv), WebM (.webm), 3GP (.3gp), and High-Efficiency Video Coding (.h265, .hevc) formats.

In one implementation, the images may be extracted from the documents 304, at step 314. The images may be extracted based on their features, using different image extraction techniques. In one implementation, the images may be extracted using an automatic image annotation technique that can label the images based on image contents. The automatic image annotation technique is dependent on how accurate a system is in detecting color, edges, texture, spatial layout, and shape-related information.

One or more of the techniques described henceforth may be used for extracting the images. Color-based extraction such as color segmentation may be used for extracting the images. Color segmentation involves identification of regions in an image based on color. Techniques like k-means clustering can be used to group pixels with similar colors together. Alternatively, feature-based extraction, such as edge detection may be used for extracting the images. Edge detection algorithms like Canny, Sobel, or Prewitt may be used to identify boundaries in an image. Alternatively, corner detection may be used for extracting the images. Corner detection involves identification of corners in an image using algorithms like Harris corner detection.

Alternatively, texture-based extraction i.e. Texture analysis may be used for extracting the images. Textures may be identified within an image using techniques like Gabor filters or Local Binary Patterns (LBP). Alternatively, shape-based extraction, such as contour detection may be used for extracting the images. Contours in the images may be identified using techniques like OpenCV's findContours function. Alternatively, object detection such as deep learning-based object detection may be used for extracting the images. In deep learning-based object detection, pre-trained deep learning models like YOLO, Faster R-CNN may be used to detect and extract objects from images. Histogram Equalization may be used for adjusting intensity distribution in an image, to enhance visibility of certain features. Alternatively, image morphology such as erosion and dilation operations may be used for extracting the images: Morphological operations may be used to modify shape and structure of objects in an image, for cleaning up or enhancing specific features.

Post extraction of the images, characters present in the images may be identified using computer vision and machine learning techniques, at step 316. The computer vision and machine learning techniques identify the characters based on certain attributes, such as text density, structure of text, font, character type, artifacts, and location.

In one implementation, the characters present in the images may be identified using OCR technique. Below provided program code may be used for implementing the OCR technique.
import pytesseract
from PIL import Image
#Path to the Tesseract executable (update this with the correct path on your system)
pytesseract.pytesseract.tesseract_cmd=r‘C:\ProgramFiles\Tesseract-OCR\tesseract.exe’
#Path to the image file you want to process
image_path=‘example_image.png’
#Open the image using PIL (Python Imaging Library)
image=Image.open(image_path)
#Use Tesseract to do OCR on the image
text=pytesseract.image_to_string(image)
#Print the extracted text
print(“Extracted Text:”)
print(text)

It must be understood that an accuracy of the OCR technique varies depending on quality of the images and the clarity of the text present in the images. The OCR technique works best with clear and well-defined text in images. If the images are noisy or have complex layouts, additional pre-processing steps might need to be performed.

The machine learning techniques used for identification of the characters may include Efficient Accurate Scene Text detector (EAST), Convolutional-Recurrent Neural Network (CRNN), and SEE-Semi-Supervised End-to-End Scene Text Recognition (STN-net/SEE). Further, Optical Character Recognition (OCR) techniques, such as MaskOCR, TransOCR, PerSec, Context-based Contrastive Learning for Scene Text Recognition (ConCLR), Automotive, Bidirectional and Iterative Network (ABINet), VisionLan, Semantic Reasoning Network (SRN), Parallel, Iterative, and Mimicking Network (PIMNet), Semantics Enhanced Encoder-Decoder Framework (SEED) or Attentional Scene Text Recognizer with Flexible Rectification (ASTER) may be used for identification of the characters.

In one implementation, the characters present in the images may be identified using EAST. Below provided program code may be used for implementing EAST using Python and OpenCV.
import cv2
import numpy as np
#Load the pre-trained EAST text detection model
net=cv2.dnn.readNet(“frozen_east_text_detection.pb”)
#Load the input image
image=cv2.imread(“example_image.jpg”)
orig_image=image.copy( )
#Get the image dimensions
height, width, _=image.shape
#Prepare the image for processing by resizing and normalizing
blob=cv2.dnn.blobFromImage(image, 1.0, (width, height), (123.68, 116.78, 103.94), swapRB=True, crop=False)
#Set the blob as input to the network and forward pass
net.setInput(blob)
output=net.forward( )
#Get scores and geometry
scores=output[0]
geometry=output[1:5]
#Define the minimum confidence score to consider
min_confidence=0.5
#Iterate over the scores
for i in range(scores.shape[2]):
   #Extract the scores and geometry for a given region
   score=scores[0, 0, i]
   if score>min_confidence:
      #Extract the coordinates of the bounding box
      x0, y0, x1, y1=(geometry[0, i, 0], geometry[1, i, 0], geometry[2, i, 0], geometry[3, i, 0])*4
      #Scale the bounding box coordinates
      x0, y0, x1, y1=int(x0), int(y0), int(x1), int(y1)
      #Draw the bounding box on the original image
      cv2.rectangle(orig_image, (x0, y0), (x1, y1), (0, 255, 0), 2)
#Display the result
cv2.imshow(“Text Detection Result”, orig_image)
cv2.waitKey(0)
cv2.destroyAllWindows( )

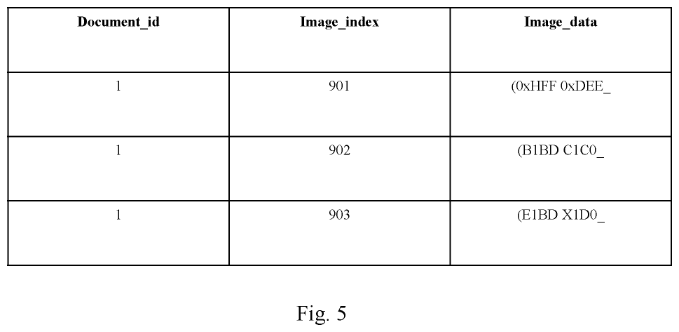

When the characters are identified to be present in an image, the image may be persisted i.e. stored in an image database 318, at step 320. In one implementation, the vector database 312 and the image database 318 may be provided as a single database such as the database 106 for storing the documents 304, the information related to the documents 304, and the images. An image index may be created for each image, and the images may be stored against respective image index, in the image database 318. FIG. 5 illustrates a portion of information stored in the image database 318, in accordance with an embodiment of the present disclosure. As illustrated, image data, corresponding image index, and an identity of a document from which the image is identified may be stored in the image database 318.

Successive to storage of the images in the image database 318, keywords may be extracted based on the characters identified from the images, at step 322. The keywords may include combination of one or more of the characters. Word embeddings may be determined for the keywords, at step 324.

The word embeddings may be provided to a unifier 326. The unifier 326 may scan the vector database 312 to identify results matching with the word embeddings. The unifier 326 may determine proximity scores based on the matching between the word embeddings related to the images and the different n-gram word embeddings of the sentence chunks obtained from the documents 304. In this manner, the sentences (of the documents 304) matching with the keywords (present in the images) may be identified, and thus association between the sentences and the images may be identified.

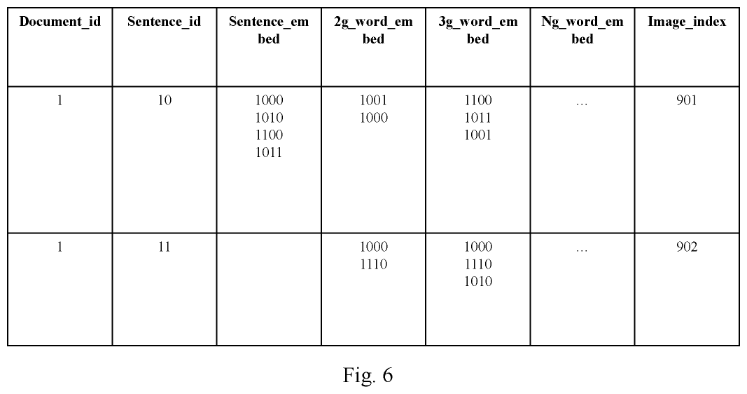

The unifier 326 may also acquire the image data from the image database 318. The unifier 326 may link the images with the results matching with the word embeddings and update the vector database 312 with the image index. FIG. 6 illustrates a portion of information stored in the vector database 312, in accordance with an embodiment of the present disclosure. As evident from FIG. 6, existing information (shown in FIG. 4) present in the vector database 312 may be updated to include the image index corresponding to a specific image present in the image database 318. In this manner, an association between textual information and visual information (images) present within a plurality of the documents 304 may be developed. Such textual information associated with the visual information may be referred as the organized data.

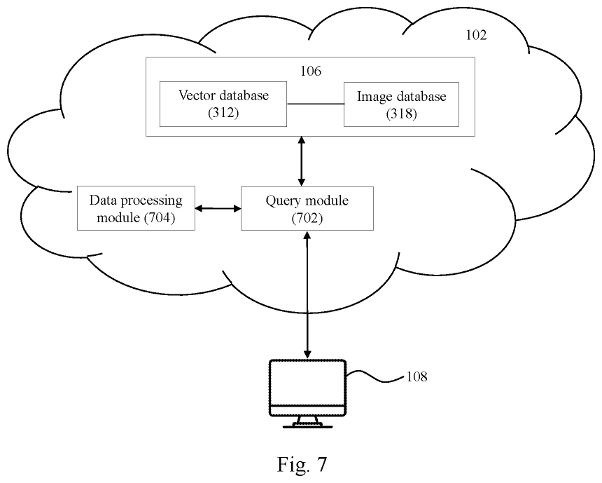

FIG. 7 illustrates the user device 108 communicating with the server 102 for accessing the organized data, in accordance with an embodiment of the present disclosure. A user requiring information on a particular subject may submit a query using the user device 108. The query may be submitted using the interface 202. The interface 202 for submitting the query can take various forms, depending on platform, application, and user experience goals.

In different implementations, the interface 202 may be present in one of the different forms described henceforth. The interface 202 may be present as a text input box allowing the users to type or paste their queries. The interface 202 may alternatively be present as voice input interface allowing the users to submit their queries using spoken language through a microphone. For example, voice-activated virtual assistants like Siri, Google Assistant, or Alexa may be used. Alternatively, the interface 202 may be form-based allowing the users to fill out a form with various fields to submit specific information. For example, online forms for submitting queries, such as contact forms or registration forms may be used. The interface 202 may alternatively be present as a dropdown menu. The users may choose from predefined options present in the dropdown menu. The interface 202 may alternatively be provided as checkbox/radio buttons for allowing filtering or search results by criteria, selecting preferences. Alternatively, the interface 202 may be present as a Command Line Interface (CLI) allowing the users to enter commands in a text-based interface for specific actions.

The interface 202 may also be present as a natural language interface allowing the users to submit queries in a natural language format. The system interprets intents of the users from the queries and provides search results in return. For example, chatbots, virtual assistants, and natural language processing interfaces may be used. Alternatively, the interface 202 may be image based allowing the users to upload images as queries for processing or analysis. Alternatively, the interface 202 may be a Augmented Reality (AR) interface allowing the users to interact with the environment through AR, often using voice or gestures. Alternatively, the interface 202 may be a multi-modal interface allowing combining of multiple input modes for a seamless user experience e.g., voice and touch.

The user device 108 may forward the query to the server 102 for obtaining a response. A query module 702 configured in the server 102 may receive and interpret the query. While interpreting, the query module 702 may identify relevant keywords from the query and scan the vector database 312 for presence of one or more documents related to such relevant keywords. The one or more documents would also be associated with related images stored in the image database 318, as described above with reference to FIG. 6.

In one implementation, a similarity metric may be applied to find a vector that is most similar to the query. Different similarity measures can be used for comparing and identifying most relevant results for the query, in the vector database 312. For example, cosine similarity may be used for measuring cosine of an angle between two vectors in a vector space. The cosine similarity ranges from −1 to 1, where 1 represents identical vectors, 0 represents orthogonal vectors, and −1 represents vectors that are diametrically opposed. Alternatively, Euclidean distance may be used for measuring a straight-line distance between two vectors in a vector space. Euclidean distance ranges from 0 to infinity, where 0 represents identical vectors, and larger values represent increasingly dissimilar vectors. By implementing a similarity measure, the query module 702 may identify the one or more documents and the related images, in response to the query.

In one implementation, the query module 702 may provide the one or more documents and the related images to a data processing module 704. The data processing module 704 may process the documents and the related images to create output files of one or more types. The output files may be created based on the user's preferences. The data processing module 704 may be able to generate a video file from the documents and the related images. The video file may be generated through aggregation of multiple images in a sequence and playing them at a predefined rate. The video file may also be overlaid with audio generated through text-to-speech conversion of textual information associated with the multiple images. Different techniques including concatenative synthesis i.e. joining pre-recorded speech segments and parametric synthesis i.e. generating speech from acoustic models may be used for generation of the audio to be used in the video file.

The data processing module 704 may also be capable of generating a PDF document from the documents and the related images. The PDF document may be created using a variety of programming languages, such as Python (using libraries like ReportLab or PyPDF2), Java (using iText or Apache PDFBox), JavaScript (using libraries like jsPDF), or specialized tools like LaTeX.

The data processing module 704 may also be capable of generating a summary of the content of the documents and may also include related images in the summary. The summary may be generated by condensing a longer piece of text into a shorter version while retaining key information and main idea. The summary may make it easier for users to grasp essential points without reading entire text. For generation of the summary, content extraction, text analysis, identification of key sentences or phrases, language simplification, and application of length limitations may be performed as key steps. The data processing module 704 may generate the summary using natural language processing (NLP) techniques, machine learning algorithms, or rule-based approaches.

One or more of the steps described above, such as text extraction, obtaining sentence chunks, determining word embeddings, sentence linking with word embeddings, character identification from images, keyword extraction from characters, and linking of textual information with images could be performed using one or more Machine Learning (ML) models. It must be understood that the ML models correspond to computational algorithms or systems capable of learning patterns and making predictions or decisions based on the learning.

ML models of different types may be used based on their learning mechanisms and applications. The ML models may be supervised learning models, such as linear regression models, logistic regression models, Support Vector Machines (SVM), decision trees and random forests, and neural networks. The ML models may be unsupervised learning models, such as K-means clustering, hierarchical clustering, Principal Component Analysis (PCA), and Generative Adversarial Networks (GANs). The ML models may be Reinforcement Learning Models (RLMs), such as Q-learning and deep reinforcement learning. The ML models may be semi-supervised and self-supervised learning models. The ML models may be Natural Language Processing (NLP) Models, such as transformer models, Recurrent Neural Networks (RNN), Long Short-Term Memory (LSTM). The ML models may be ensemble models developed through bagging or boosting techniques.

After training the ML models on all the documents stored in the data sources 104, the ML model may be executed to implement functions of the query module 702 and the data processing module 704. Specifically, the ML model would scan the vector database 312 in response to a query obtained from a user, and identify relevant information as a result. The relevant information may be provided to the user in a requested format.

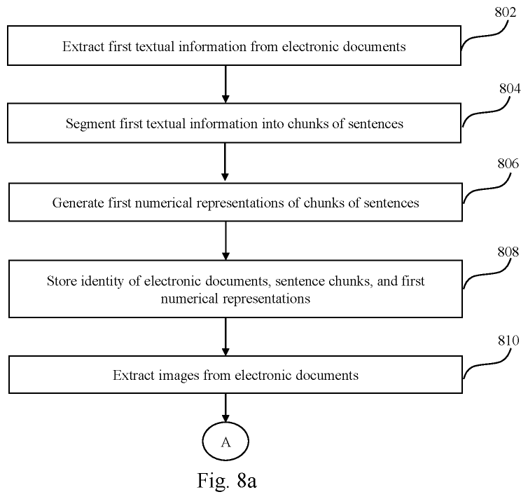

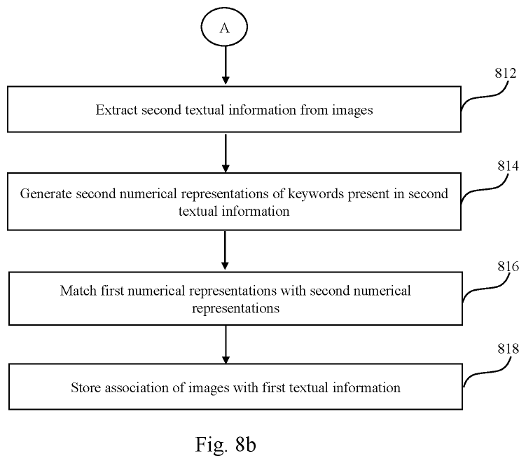

FIGS. 8a and 8b cumulatively illustrate a flow chart of a method of organizing data, in accordance with an embodiment of the present disclosure. In this regard, each block may represent a module, segment, or portion of code, which comprises one or more executable instructions for implementing the specified logical function(s). It should also be noted that in some alternative implementations, the functions noted in the blocks may occur out of the order noted in the drawings. For example, two blocks shown in succession in FIGS. 8a and 8b may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

At block 802, a first textual information may be extracted from one or more electronic documents. The first textual information may be extracted using a suitable technique such as Optical Character Recognition (OCR), Regular Expressions (Regex), Natural Language Processing (NLP), keyword extraction, Information Retrieval (IR), document Structure analysis, PDF text extraction, Named Entity Recognition (NER), and web scraping.

At block 804, the first textual information may be segmented into one or more chunks of sentences (alternatively referred as sentence chunks) including at least one word. The first textual information may be segmented based on pre-defined rules. The sentence chunks may be made up of individual words or words that are defined using part-of-speech tags. The first textual information may be segmented based on pre-defined rules i.e. text extraction rules. The text extraction rules may assist in identification of words or patterns to be included or excluded from a sentence chunk. Specifically, the text extraction rules refer to predefined patterns or criteria used for identification of specific information from the documents.

At block 806, first numerical representations i.e. word embeddings of the one or more chunks may be generated. The first numerical representations may be generated using a machine learning model. Word embeddings are numeric vectors representing words in a lower-dimensional space, and helps in preserving of syntactical and semantic information. The word embeddings allow words with similar meanings to have a similar representation. The word embeddings may be determined through different methods, such as machine learning models, feature extraction algorithms, Word2Vec, and Global Vectors for Word Representation (GloVe).

In different implementations, based on requirements, different n-gram word embeddings such as, 2 g word embeddings or 3 g word embeddings may be generated. The n-gram word embeddings represent contiguous sequence of n items from a given sample of text.

At block 808, identity of each of the one or more electronic documents, the one or more chunks, and the first numerical representations may be stored in a memory. Further, an association between the one or more chunks, the first numerical representations, and a respective electronic document of the one or more electronic documents is also stored.

At block 810, one or more images may be extracted from the one or more electronic documents. The images may be extracted based on their features, using different image extraction techniques, such as color segmentation, k-means clustering, feature-based extraction, edge detection, and corner detection.

At block 812, a second textual information may be extracted from the one or more images. The second textual information may include one or more keywords. The second textual information may be extracted using a suitable technique such as Optical Character Recognition (OCR), Regular Expressions (Regex), Natural Language Processing (NLP), keyword extraction, Information Retrieval (IR), document Structure analysis, PDF text extraction, Named Entity Recognition (NER), and web scraping.

At block 814, second numerical representations i.e. word embeddings of the one or more keywords may be generated. In different implementations, based on requirements, different n-gram word embeddings such as, 2 g word embeddings or 3 g word embeddings may be generated. The n-gram word embeddings represent contiguous sequence of n items from a given sample of text. The second numerical representations may be generated using the machine learning model.

At block 816, the first numerical representations may be matched with the second numerical representations for determining an association of the one or more images with the first textual information based on the association of the first numerical representations with the one or more chunks.

At block 818, the memory may be updated for storing the association of the one or more images with the first textual information. Specifically, the memory may be updated to include an image index corresponding to a specific image. The textual information associated with the visual information may be referred as the organized data. Successively, any user query may be run on the organized data and search results matching the user query may be provided to the user. Such search results would include both i.e. the textual information and the visual information (images).

Upon implementing the above described methodology, the proposed system is able to provide one or more technical advantages mentioned successively. The system extracts text and images from electronic documents, identifies an association between the images and the text, and prepares an electronic document including the text and one or more images associated with the text. Usage of the vector database by the system results in higher speed of storage and retrieval of information. Further, by accessing the output provided by the proposed system, for example the video, the PDF document, or the summary, the user can quickly obtain required information in a required format, without requiring to navigate through several documents.

An embodiment of the invention may be an article of manufacture in which a machine-readable medium (such as microelectronic memory) has stored thereon instructions which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components. Also, although the discussion focuses on uplink medium control with respect to frame aggregation, it is contemplated that control of other types of messages are applicable.

One or more modules described above, such as the unifier, the query module, and the data processing module may be understood as a collection of computer program instructions executable by the processor to perform intended tasks.

In the above description, for purposes of explanation, numerous specific details are set forth in order to provide a thorough understanding of the present systems and methods. It will be apparent the systems and methods may be practiced without these specific details. Reference in the specification to “an example” or similar language means that a particular feature, structure, or characteristic described in connection with that example is included as described, but may not be included in other examples.

A computer network may be implemented using wired and/or wireless communication technologies. The computer network may comprise various network components such as switches, Provide Edge (PE) routers, Customer Edge (CE) routers, intermediate routers, bridges, computers, servers, and the like. The network devices present in the computer network may implement an Interior Gateway Protocol (IGP) including, but not limited to, Open Shortest Path First (OSPF), Routing Information Protocol (RIP), Intermediate System to Intermediate System (IS-IS), and Enhanced Interior Gateway Routing Protocol (EIGRP).

An interface may be used to provide input or fetch output from the system. The interface may be implemented as a Command Line Interface (CLI), Graphical User Interface (GUI). Further, Application Programming Interfaces (APIs) may also be used for remotely interacting with edge systems and cloud servers.

A processor may include one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor), MIPS/ARM-class processor, a microprocessor, a digital signal processor, an application specific integrated circuit, a microcontroller, a state machine, or any type of programmable logic array.

A memory may include, but is not limited to, non-transitory machine-readable storage devices such as hard drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

The terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

Any combination of the above features and functionalities may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set as claimed in claims that issue from this application, in the specific form in which such claims issue, including any subsequent correction.

What is claimed is:

1. A method of organizing data, the method comprising:
extracting, by a processor, a first textual information from one or more electronic documents;
segmenting, by the processor, the first textual information into one or more chunks of sentences including at least one word, based on pre-defined rules;
generating, by the processor, using a machine learning model, first numerical representations of the one or more chunks;
storing, in a memory, identity of each of the one or more electronic documents, the one or more chunks, and the first numerical representations, wherein an association between the one or more chunks, the first numerical representations, and a respective electronic document of the one or more electronic documents is also stored;
extracting, by the processor, one or more images from the one or more electronic documents;
extracting, by the processor, a second textual information from the one or more images, wherein the second textual information includes one or more keywords;
generating, by the processor, using the machine learning model, second numerical representations of the one or more keywords;
matching, by the processor, the first numerical representations with the second numerical representations for determining an association of the one or more images with the first textual information based on the association of the first numerical representations with the one or more chunks; and
updating, by the processor, the memory for storing the association of the one or more images with the first textual information.

2. The method as claimed in claim 1, wherein the memory is updated when a value of the matching of the first numerical representations and the second numerical representations is greater than a pre-defined threshold.

3. The method as claimed in claim 1, wherein the one or more key words are extracted using optical character recognition.

4. The method as claimed in claim 1, further comprising generating an electronic document including the first textual information and the one or more images associated with the first textual information.

5. The method as claimed in claim 1, wherein the pre-defined rules are deployed using one or more of semantic text classification models and semantic text extraction models.

6. The method as claimed in claim 1, wherein the association of the one or more images with the first textual information includes one or more of an index, identity, and link to location of the one or more images contained in the one or more electronic documents.

7. The method as claimed in claim 1, wherein the association of the one or more images with the first textual information is stored as a single entry of a table.

8. The method as claimed in claim 1, further comprising:
receiving a user query including one or more query words;
determining a similarity between the one or more query words and the first textual information; and
providing a response including the first textual information and the one or more images associated with the first textual information based on the similarity between the one or more query words and the first textual information.

9. The method as claimed in claim 8, wherein the user query is processed using a natural language processing technique for determining the one or more query words.

10. The method as claimed in claim 1, further comprising generating a video using the one or more images associated with the first textual information overlaid on a speech synthesized audio sequence of the first textual information.

11. The method as claimed in claim 1, wherein the one or more images are captured from a video file.

12. A system comprising:
a processor;
a memory storing program instructions which, when executed by the processor, causes the processor to:
extract a first textual information from one or more electronic documents;
segment the first textual information into one or more chunks of sentences including at least one word, based pre-defined rules;
generate first numerical representations of the one or more chunks, using a machine learning model;
store identity of each of the one or more electronic documents, the one or more chunks, and the first numerical representations in the memory, wherein an association between the one or more chunks, the first numerical representations, and a respective electronic document of the one or more electronic documents is also stored;
extract one or more images from the one or more electronic documents;
extract a second textual information from the one or more images, wherein the second textual information includes one or more keywords;
generate using the machine learning model, second numerical representations of the one or more keywords;
match the first numerical representations with the second numerical representations for determining an association of the one or more images with the first textual information based on the association of the first numerical representations with the one or more chunks; and
update the memory for storing the association of the one or more images with the first textual information.

13. The system as claimed in claim 12, wherein the memory is updated when a value of the matching of the first numerical representations and the second numerical representations is greater than a pre-defined threshold.

14. The system as claimed in claim 12, further comprising program instructions causing the processor to generate an electronic document including the first textual information and the one or more images associated with the first textual information.

15. The system as claimed in claim 12, wherein the pre-defined rules are deployed using one or more of semantic text classification models and semantic text extraction models.

16. The system as claimed in claim 12, wherein the association of the one or more images with the first textual information includes one or more of an index, identity, and link to location of the one or more images contained in the one or more electronic documents.

17. The system as claimed in claim 12, wherein the association of the one or more images with the first textual information is stored as a single entry of a table.

18. The system as claimed in claim 12, further comprising program instructions causing the processor to:
receive a user query including one or more query words;
determine a similarity between the one or more query words and the first textual information; and
provide a response including the first textual information and the one or more images associated with the first textual information based on the similarity between the one or more query words and the first textual information.

19. The system as claimed in claim 12, further comprising program instructions causing the processor to generate a video using the one or more images associated with the first textual information overlaid on a speech synthesized audio sequence of the first textual information.

20. A non-transitory computer-readable storage medium storing program instructions for organizing data, the instructions, when executed, perform the steps of:
extracting a first textual information from one or more electronic documents;
segmenting the first textual information into one or more chunks of sentences including at least one word, based on pre-defined rules;
generating using a machine learning model, first numerical representations of the one or more chunks;
storing, in the computer readable storage medium, identity of each of the one or more electronic documents, the one or more chunks, and the first numerical representations, wherein an association between the one or more chunks, the first numerical representations, and a respective electronic document of the one or more electronic documents is also stored;
extracting one or more images from the one or more electronic documents;
extracting a second textual information from the one or more images, wherein the second textual information includes one or more keywords;
generating using the machine learning model, second numerical representations of the one or more keywords;
matching the first numerical representations with the second numerical representations for determining an association of the one or more images with the first textual information based on the association of the first numerical representations with the one or more chunks; and
updating the computer readable storage medium for storing the association of the one or more images with the first textual information.
